(19) United States
(12) Patent Application Publication
(10) Pub. No.: US 2012/0318097 A1
(43) Pub. Date: Dec. 20, 2012

(54) VEHICLE CONTROL DEVICE, PARTICULARLY FOR CONTROLLING THE VEHICLE ACCELERATION AND BRAKING SYSTEM

(76) Inventor: Mauro Ricci, Rimini (RN) (IT)

(21) Appl. No.: 13/261,011

(22) PCT Filed: May 20, 2010
(86) PCT No.: PCT/EP10/56933

§ 371 Date: Nov. 14, 2011

(30) Foreign Application Priority Data
May 22, 2009 (IT) MI 2009 A 000911

(51) Int. Cl. G05G 1/10

(52) U.S. Cl. 74/553

(57) ABSTRACT

A vehicle control device, particularly for controlling an accelerating and braking vehicle system, comprises a knob, associated with a control member such as a handlebar or steering wheel, and including at least a circumferential recess housing herein an end portion of a brake control cable coupled to the vehicle braking system thereby, by turning clockwise the knob the vehicle braking system is operated, the knob further controlling the vehicle fuel supplying system.

### BACKGROUND OF THE INVENTION

The present invention relates to a vehicle control device, particularly for controlling the vehicle accelerating and braking system.

As is known, in a motorcycle, for example, control assemblies are conventionally arranged on the motorcycle handlebar, so that, in driving the motorcycle, it is not possible to remove the hands from the handlebar, which comprises a right handgrip or knob, which is coupled to the fuel injection system by a flexible cable for controlling the gaseous fuel mixture injection, a right lever for controlling the motorcycle front brake, and a left lever switching on and off of the motorcycle clutch.

The handlebar supports moreover control push-buttons for the motorcycle acoustic signaling means and lights, and a further push-button for operating the motorcycle starting motor assembly.

Said motorcycle includes moreover pedal control assemblies comprising a rear brake lever, usually arranged on the right of the motorcycle, and a gear ratio changing rod.

In a motorcycle including an automatic gear casing, or a continuously gear ratio varying assembly, and in all motor bicycles, the handlebar clutch left lever is usually omitted, and replaced by further lever controlling the rear braking assembly.

All prior motorcycles, motor bicycles, and so on comprise two separate and discrete control assemblies, that is a handgrip or knob accelerator and a main brake lever control assembly.

Thus, the motorcycle driver, for performing slow down operation, must necessarily at first turn the accelerator knob to a closing position and then operate the brake lever by the fingers of the same hand.

This requires a great skillness by the driver and, in an emergency case, would involve a delay between the accelerator or gas driving operation and the brake lever actuation, which delay is due to the time necessary for removing the fingers from the acceleration knob and bring said fingers on the brake lever.

In actual practice, some motorcyclists usually hold one or two fingers on the brake lever, during a regular motorcycle travel, to be ready for immediately providing a braking operation in an emergency condition; however, this is a fatiguing position for the motorcyclist hand and forearm, and cannot be achieved if the brake lever is not properly inclined with respect to the handlebar.

### SUMMARY OF THE INVENTION

Accordingly, the aim of the present invention is to provide such a novel control device for controlling a vehicle main braking system, which overcomes all the above disclosed drawbacks.

Within the scope of the above mentioned aim, a main object of the invention is to provide such a vehicle control device which may be advantageously applied to any desired type of motor vehicles.

Another object of the present invention is to provide such a vehicle control device which may also be advantageously used for motorless vehicles.

Another object of the present invention is to provide such a vehicle control device which, owing to its specifically designed constructional features, is very reliable and safe in operation.

Yet another object of the present invention is to provide such a vehicle control device which may be easily made starting from easily available elements and materials and which, moreover, is very competitive from a mere economic standpoint.

According to one aspect of the present invention, the above mentioned aim and objects, as well as yet other objects, which will become more apparent hereinafter, are achieved by a vehicle control device, particularly for controlling a vehicle braking system, characterized in that said vehicle control device comprises a knob, coupled to a vehicle control member, such as a handlebar or a steering wheel, said knob including at least circumferential recess for housing herein an end portion of a control cable coupled to said vehicle braking system, thereby, as said knob is clockwise turned, the vehicle braking system is operated.

That same knob or handgrip also forming, in a motor vehicle, the fuel supplying system control of said vehicle.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is a side cross sectional view of the control device according to the present invention;

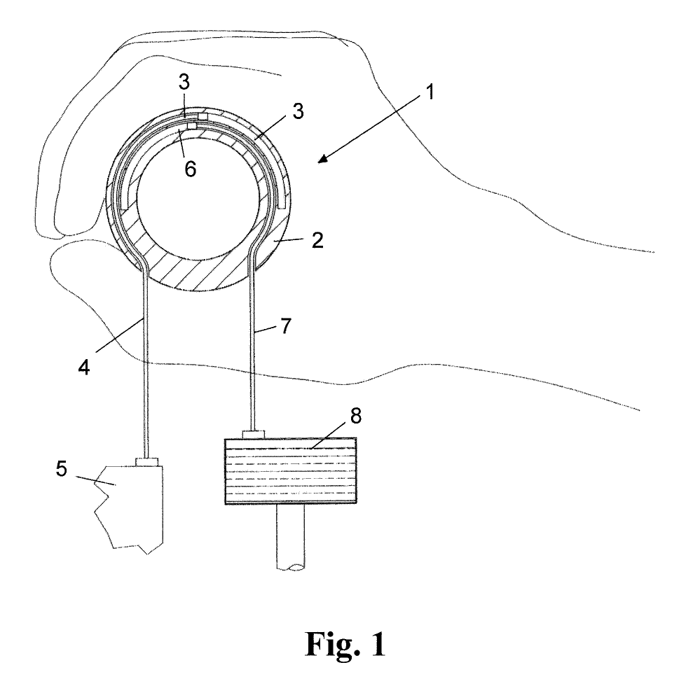

FIG. 2 is a view similar to FIG. 1, but showing the device being used for providing a vehicle accelerating function;

FIG. 3 is a view similar to FIGS. 1 and 2, but showing the device being used in a vehicle braking operation;

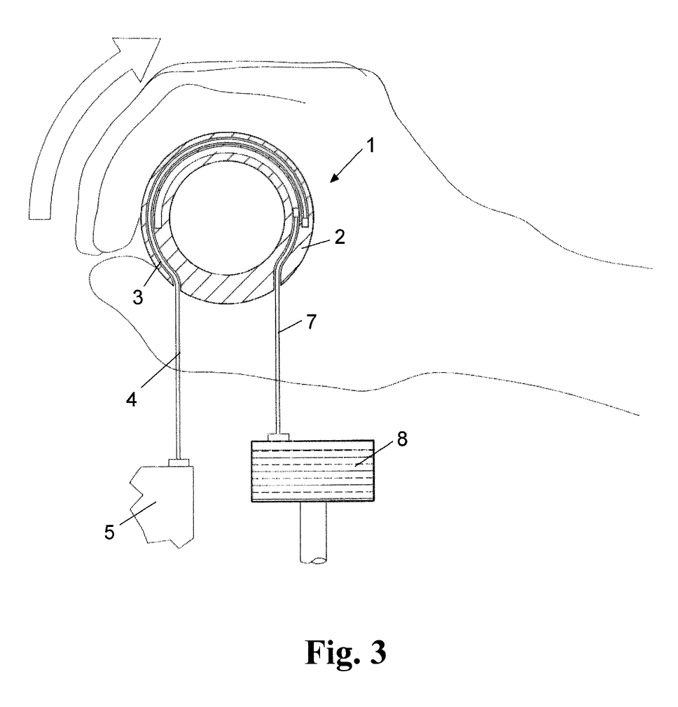

FIG. 4 is a front view of a car steering wheel, including a control device according to the present invention; and

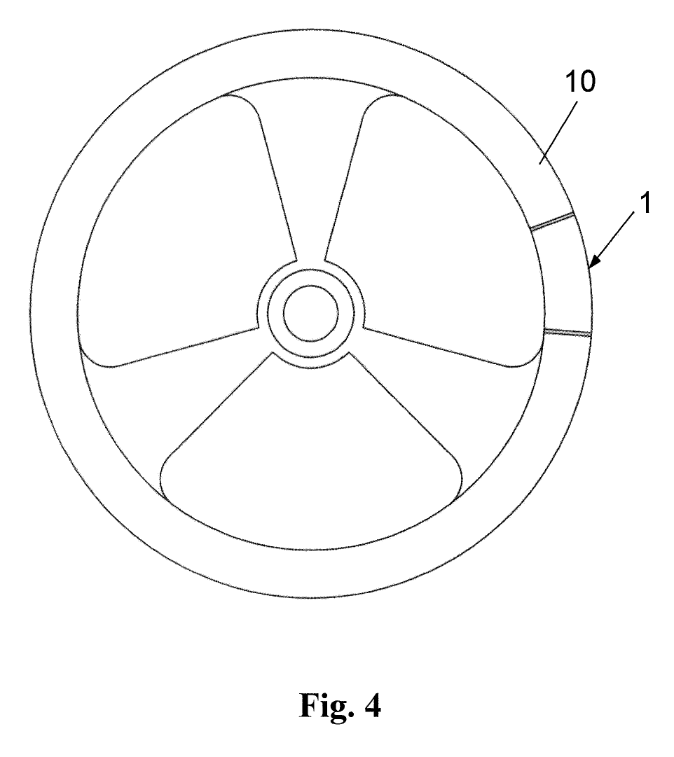

FIG. 5 is a further schematic view of a handlebar including a control device according to the present invention.

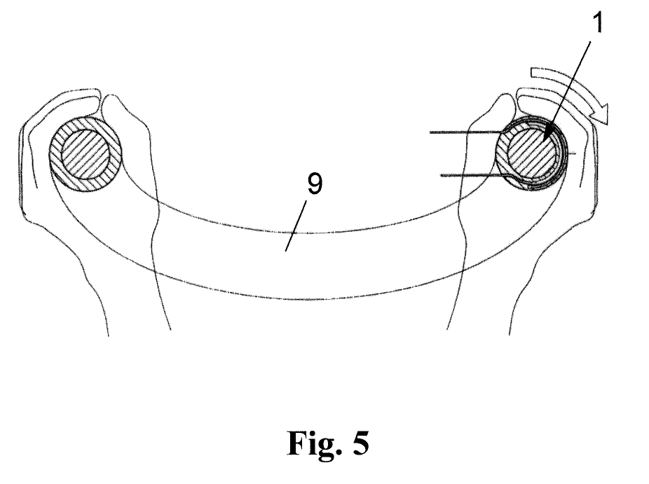

### DESCRIPTION OF THE PREFERRED EMBODIMENTS

With reference to the number references of the above mentioned figures, the control device according to the present invention, which has been generally indicated by the reference number 1, comprises a knob or handgrip 2 including a first circumferential recess 3, for housing herein an end portion of an accelerator control cable 4, which is connected to the engine fuel supplying system, generally indicated by the reference number 5.

According to the present invention, the knob 2 comprises a second circumferential recess 6 housing therein an end portion of a brake control cable 7, coupled to a hydraulic pump 8 or other vehicle braking system.

The control device 1 according to the present invention operates as follows.

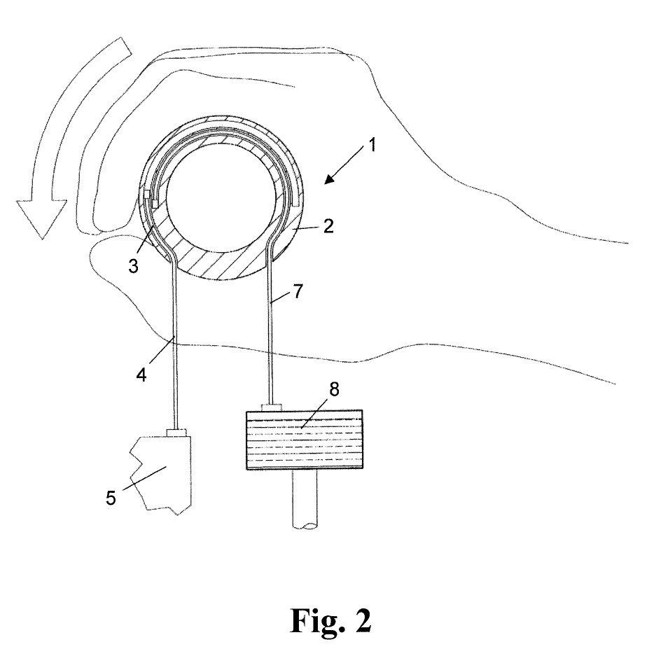

As a driver operates the knob or handgrip in a conventional manner, that is by turning said knob clockwise as shown in FIG. 2, the accelerator cable 4 is operated by a controlled pulling force thereby causing the vehicle to accelerate, whereas, for slowing down, the knob will be actuated in an opposite direction, thereby “closing the gas”.

According to the present invention as, by continuously turning the knob, the dead point or center, corresponding to a rest position of the knob is passed through, the brake cable 7 will be subjected to a controlled pulling force, thereby allowing to adjust, in a very precise manner, the braking operation, while substantially fully eliminating any reactive or inertial braking time.

Another advantage of the control device according to the present invention is that the braking operation is a self-evident one, like the gas closing; moreover, by a single operation it is possible to shut off the fuel supply while braking the vehicle, differently from conventional systems in which the throttle and brakes are controlled by separated and different devices, to be separately driven by the driver.

Moreover, the control device according to the present invention may be easily applied to a motorcycle, bicycle, tricycle and quadricycle handlebar 9, and also to a motor vehicle steering wheel 10, and may be also advantageously used for controlling a bicycle braking assembly.

It has been found that the invention fully achieves the intended aim and objects.

In fact, the invention has provided a novel brake control system which may be easily operated and allows to greatly reduce the reactive braking time.

In practicing the invention, the used materials, as well as the contingent size and shapes, can be any, according to requirements.

1. A vehicle control device, particularly for controlling a vehicle braking system, characterized in that said vehicle control device comprises a vehicle control handlebar or steering wheel supporting a knob including at least a circumferential recess for housing therein an end portion of a control cable coupled to said vehicle braking system, thereby, as said knob is clockwise turned, said vehicle braking system is operated.

2. A control device, according to claim 1, characterized in that said knob forms a fuel supplying system control of said vehicle.

3. A control device, according to claim 1, characterized in that said knob comprises a first circumferential recess for receiving an end portion of a control cable of the vehicle fuel supplying system, and a second circumferential recess, for receiving an end portion of said control cable of said vehicle brake assembly coupled to a hydraulic pump or other braking system of said vehicle.

4. A control device, according to claim 1, characterized in that said steering wheel is a motor vehicle steering wheel.

5. A control device, according to claim 1, characterized in that said handlebar is a bicycle or other non motorized vehicle handlebar.
